(19) United States
(12) Patent Application Publication
(10) Pub. No.: US 2021/0035126 A1
(43) Pub. Date: Feb. 4, 2021

(54) DATA PROCESSING METHOD, SYSTEM AND COMPUTER DEVICE BASED ON ELECTRONIC PAYMENT BEHAVIORS

(71) Applicant: BAIDU ONLINE NETWORK TECHNOLOGY (BEIJING) CO., LTD., Beijing (CN)

(72) Inventor: Bedong CHEN, Beijing (CN)

(21) Appl. No.: 16/879,743

(22) Filed: May 20, 2020

Related U.S. Application Data
(63) Continuation of application No. 15/301,359, filed on Sep. 30, 2016, now abandoned.

(30) Foreign Application Priority Data
Feb. 13, 2015 (CN) 2015100785904

(51) Int. Cl. G06Q 30/02; G06F 16/9535; H04L 29/08

(52) U.S. Cl. CPC G06Q 30/0201; G06F 16/9535; H04L 67/22; G06Q 30/0271; G06Q 30/0255

(57) ABSTRACT

Embodiments of the present invention provide a data processing method, system, and computer device based on electronic payment behaviors. The method includes: acquiring log information formed by users' Internet-surfing; acquiring consumption information generated by the users' consumption via electronic payment; collecting, from the log information, first user information of users viewing specified content data; collecting, from the consumption information, second user information of users paying for a product or service related to the specified content data; and mapping the first user information with the second user information based on a user information mapping relation database storing multiple pieces of information of the users, to acquire user behavior association data indicating that the first user information and the second user information belong to a same user. The technical solution of the present invention implements an approach of associating Internet-surfing behavior data of users with their consumption behavior data, so that a merchant or user performs specific data mining by using the user behavior association data to acquire more valuable information.

This application is a continuation of U.S. patent application Ser. No. 15/301,359, which was filed on Sep. 30, 2016, which is a 371 National Stage of International Patent Application No. PCT/CN2015/088901, filed Sep. 2, 2015, which claims the benefit of Chinese Patent Application No. 201510078590.4, filed with the Chinese Patent Office on Feb. 13, 2015, the content of which are incorporated herein by reference in its entireties.

### TECHNICAL FIELD

The present invention relates to the field of communication technology, and specifically to a data processing method, system and computer device based on electronic payment behaviors.

### BACKGROUND

In the era of mobile Internet, many merchants post service advertisements or set up product and service webpages on the Internet to attract people to purchase products in stores. For search engine companies, as well as merchants, collecting statistics in relation to the association between webpage clicking behavior and information about in store purchase is of importance to their service optimization.

Currently, collecting statistics in relation to the association between users' webpage clicking behavior and information about purchase in stores is mainly performed by manually querying consumers and recording, and the efficiency of the statistics is low. In the prior art, there are indoor positioning technologies for automatically detecting whether users are in stores. However, these indoor positioning technologies have significant inaccuracies and high error rates. In addition, categories of consumed products users consumed in stores are unknown, and cannot be associated with users' webpage clicking behavior.

### SUMMARY

Embodiments of the present invention provide a data processing method, system and computer device based on electronic payment behaviors, to implement a method of associating Internet-surfing behavior data of users with their consumption behavior data.

To achieve the above objective, the embodiments of the present invention provide a data processing method based on electronic payment behaviors, including:

acquiring log information formed by users' Internet-surfing;

acquiring consumption information generated by the users' consumption via electronic payment;

collecting, from the log information, first user information of users viewing specified content data;

collecting, from the consumption information, second user information of users paying for a product or service related to the specified content data; and

mapping the first user information with the second user information based on a user information mapping relation database storing multiple pieces of information of the users, to acquire user behavior association data indicating that the first user information and the second user information belong to a same user.

The embodiments of the present invention further provide a data processing system based on electronic payment behaviors, including:

a first acquisition module, for acquiring log information formed by users' Internet-surfing;

a second acquisition module, for acquiring consumption information generated by the users' consumption via electronic payment;

a first collection module, for collecting, from the log information, first user information of users viewing specified content data;

a second collection module, for collecting, from the consumption information, second user information of users paying for a product or service related to the specified content data; and

a mapping module, for mapping the first user information with the second user information based on a user information mapping relation database storing multiple pieces of information of the users, to acquire user behavior association data indicating that the first user information and the second user information belong to a same user.

The embodiments of the present invention provide a computer device, including: a processor;

a memory; and

one or more programs, stored in the memory, and configured such that the one or more processors execute instructions for executing a data processing method based on electronic payment behaviors comprised in the one or more programs, the data processing method based on electronic payment behaviors comprising:

acquiring log information formed by users' Internet-surfing;

acquiring consumption information generated by the users' consumption via electronic payment; collecting, from the log information, first user information of users viewing specified content data;

collecting, from the consumption information, second user information of users paying for a product or service related to the specified content data; and mapping the first user information with the second user information based on a user information mapping relation database storing multiple pieces of information of the users, to acquire user behavior association data indicating that the first user information and the second user information belong to a same user.

The data processing method, system and computer device based on electronic payment behaviors provided by the embodiments of the present invention map, through a user information mapping relation database, the log information formed upon the users' Internet-surfing with the consumption information generated by the users' consumption via electronic payment, to acquire user behavior association data of the same user, and then specific data mining is performed by using the user behavior association data to acquire more valuable information.

### BRIEF DESCRIPTION OF THE DRAWINGS

FIG. 1 is a flow chart of a data processing method based on electronic payment behaviors provided by an embodiment of the present invention;

FIG. 2 is a flow chart of a data processing method based on electronic payment behaviors provided in another embodiment of the present invention;

FIG. 3 is a schematic structural diagram of a data processing system based on electronic payment behaviors provided in an embodiment of the present invention;

FIG. 4 is a schematic structural diagram of a data processing system based on electronic payment behaviors provided in another embodiment of the present invention; and

FIG. 5 is a schematic structural diagram of a computer device provided in an embodiment of the present invention.

### DETAILED DESCRIPTION OF EMBODIMENTS

Embodiments of the present invention associate, by using a pre-generated user information mapping relation database, behavior information of users viewing content data when surfing the Internet with consumption information of users consuming via electronic payment. The technical solutions of the embodiments of the present invention are applicable to association processing of preliminary data for analyzing user consumption behaviors.

### First Embodiment

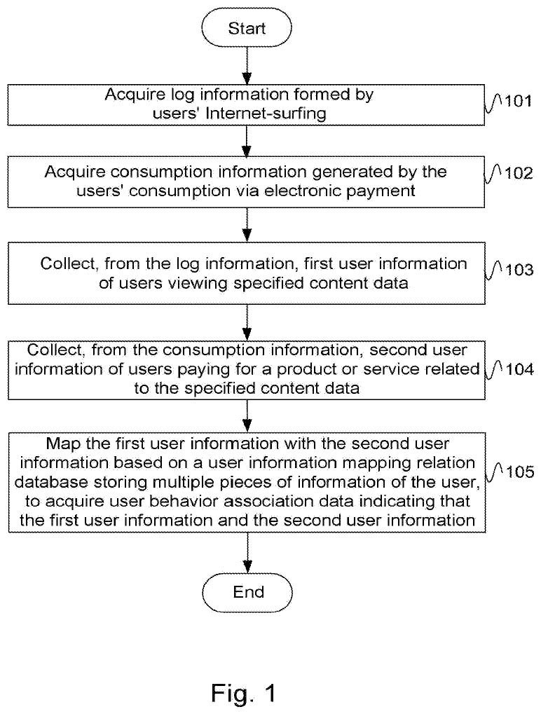

FIG. 1 is a flow chart of a data processing method based on electronic payment behaviors provided in an embodiment of the present invention. The method may be executed by a system or server having a data processing function. As shown in FIG. 1,the data processing method based on electronic payment behaviors specifically includes:

S101, acquire log information formed by users' Internet-surfing.

A lot of log information may be generated when a user surfs the Internet, and the log information is stored in a server at the network side automatically after being generated. Specific Internet-surfing behavior data of the user, such as user information used for viewing content data, may be known by acquiring the log information of the user from the server.

S102, acquire consumption information generated by the users' consumption via electronic payment.

Nowadays, many users tend to conduct consumption via electronic payment, e.g., by logging in an electronic payment software on a mobile phone terminal to make on-line payment for a consumption order. Corresponding consumption information, such as product or service information of a paid consumption order and user information during payment, may be generated by the users' consumption via electronic payment.

S103, collect, from the log information, first user information of users viewing specified content data.

The specified content data may be data on a specified product or service. The so-called first user information is related information of users viewing the specified content data, e.g., a Cell phone Unique Identification (CUID) and a User Identification number (User ID) used when the user views the content data, and a Media Access Control (MAC) address of a terminal device used when the user surfs the Internet.

S104, collect, from the consumption information, second user information of users paying for a product or service related to the specified content data.

The specified content data corresponds to the specified content data in step S103. For example, the specified content data may be advertisement content of a product or service published on the Internet by a merchant, and the product or service related to the specified content data is the same product or service provided by the merchant. The so-called second user information is consumption-related information of users consuming the product or service related to the specified content data via electronic payment, e.g., a CUID and a User ID used when the user conducts consumption via electronic payment, and a MAC address of a terminal device used during the user's on-line consumption.

S105, mapping the first user information with the second user information based on a user information mapping relation database storing multiple pieces of information of the user, to acquire user behavior association data indicating that the first user information and the second user information belong to the same user.

To associate the behavior information of the users viewing specified content data when surfing the Internet with the product or service consumed via electronic payment, in this embodiment, a lot of user information is acquired by collecting the log information of the users, cookie data in advance, etc. The information is tracked and data-associated to obtain correlations between different types of user information of the same user or between multiple pieces of different user information of the same type of the same user, and a user information mapping relation database is constructed based on these correlations. Each user stored in the user information mapping relation database corresponds to multiple pieces of user information, and the user information has mapping relations. For example, one user may correspond to multiple types of user information such as a CUID, a User ID, and a MAC address of a terminal device used.

The first user information and the second user information are mapped by using the user information mapping relation database, to determine which information in the first user information and in the second user information is user information corresponding to the same user. Related data of the same user is associated to generate user behavior association data corresponding to the user. For example, the specified content data viewed by the user in a first user identity and data on a product or service consumed by the same user in a second user identity via electronic payment may be combined to function as the user behavior association data of the user.

The data processing method based on electronic payment behaviors provided in the embodiment of the present invention maps, in the user information mapping relation database storing multiple pieces of information of the users, the first user information of the users viewing specified content data collected from the acquired user log information with the second user information of the users paying for the product or service related to the specified content data collected from the acquired consumption information of the users' consumption via electronic payment, thereby acquiring the user behavior association data indicating that the first user information and the second user information belong to the same user. The solution associates Internet-surfing behavior data of users with their consumption behavior data by using the mapping relations between multiple pieces of user information corresponding to the same user as a bridge, so that a merchant or user performs targeted data mining by using the user behavior association data to acquire more valuable information.

### Second Embodiment

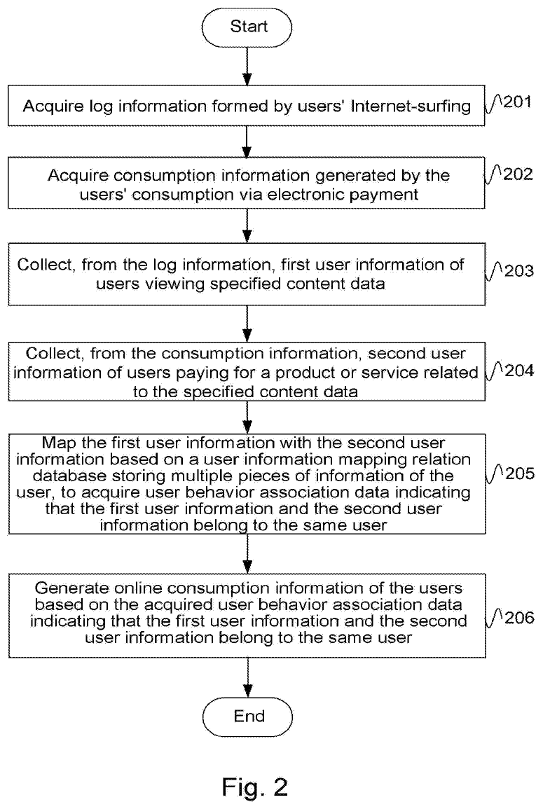

FIG. 2 is a flow chart of a data processing method based on electronic payment behaviors provided in another embodiment of the present invention, and is a specific implementation of the method embodiment as shown in FIG. 1. As shown in FIG. 2a, the data processing method based on electronic payment behaviors specifically includes:

S201, acquire log information formed by users' Internet-surfing.

S202, acquire consumption information generated by the users' consumption via electronic payment.

S203, collect, from the log information, first user information of users viewing specified content data.

S204, collect, from the consumption information, second user information of users paying for a product or service related to the specified content data.

S205, map the first user information with the second user information based on a user information mapping relation database storing multiple pieces of information of the user, to acquire user behavior association data indicating that the first user information and the second user information belong to the same user.

The concrete processes of the above mentioned steps S201-S205 may refer to the corresponding descriptions of steps S101 to S105, and will not be repeated herein.

After the above mentioned user behavior association data is acquired, further data mining may be performed for the data, thereby acquiring information having targeted values. For example, after step S205, step S206 may be subsequently executed.

S206, generate online consumption information of the users based on the acquired user behavior association data indicating that the first user information and the second user information belong to the same user.

The so-called online consumption information refers to consumption data information describing that the user consumes a product or service related to the specified content data via electronic payment after viewing the specified content data online.

For example, in-store consumption rate information of the users may be generated based on the number of first users and the number of second users corresponding to the user behavior association data.

Specifically, a ratio of the number of all first users to the number of second users may be taken as the in-store consumption rate information of users consuming the product or service via electronic payment. Here, it should be noted that users who only view the specified content data online but do not consume the product or service associated with the specified content via electronic payment are not taken as statistical objects of the in-store consumption rate.

The data processing method based on electronic payment behaviors provided in the embodiment of the present invention provides a specific instance of performing data mining through the acquired user behavior association data on the basis of the method embodiment shown in FIG. 1, that is, the online consumption information, such as the in-store consumption rate, of the users is acquired based on the specified content viewed by the users when surfing the Internet and user conditions of the users using electronic payment, to facilitate subsequent data mining.

The above descriptions are merely specific implementations of the present invention, but the protection scope of the present invention is not limited thereto, and variations or replacements that can be readily envisaged by persons skilled in the art without departing from the technical scope disclosed in the present invention shall fall within the protection scope of the present invention. Therefore, the protection scope of the present invention shall be defined by the protection scope of the claims.

### Third Embodiment

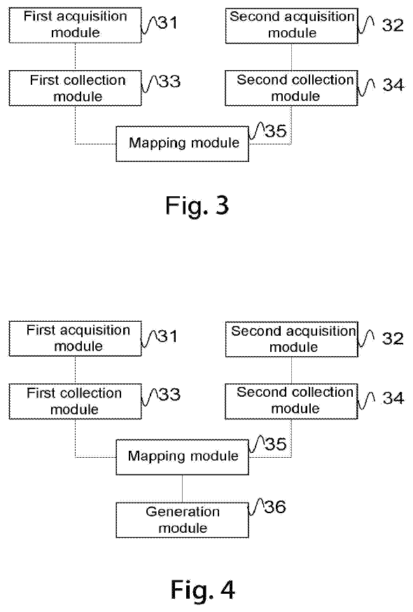

FIG. 3 is a schematic structural diagram of a data processing system based on electronic payment behaviors provided in an embodiment of the present invention, and the system can execute the steps of the method as shown in FIG. 1. As shown in FIG. 3, the data processing system based on electronic payment behaviors specifically includes a first acquisition module 31, a second acquisition module 32, a first collection module 33,a second collection module 34, and a mapping module 35.

The first acquisition module 31 is used to acquire log information formed by users' Internet-surfing.

The second acquisition module 32 is used to acquire consumption information generated by the users' consumption via electronic payment.

The first collection module 33 is used to collect, from the log information, first user information of users viewing specified content data. The second collection module 34 is used to collect, from the consumption information, second user information of users paying for a product or service related to the specified content data.

The mapping module 35 is used to map the first user information with the second user information based on a user information mapping relation database storing multiple pieces of information of the user, to acquire user behavior association data indicating that the first user information and the second user information belong to a same user.

Further, as shown in FIG. 4, on the basis of the embodiment shown in FIG. 3, the system may further include:

a generation module 36, for generating online consumption information of the users based on the acquired user behavior association data indicating that the first user information and the second user information belong to the same user.

Further, the generation module 36 may be specifically used to:

generate in-store consumption rate information of the users based on the number of first users and the number of second users corresponding to the user behavior association data.

Further, the user information may include at least one of:

a Cell phone Unique Identification (CUID), a User Identification number (User ID), and a Media Access Control (MAC) address of the user.

The steps of the method in the embodiment as shown in FIG. 2 may be executed by the data processing system based on electronic payment behaviors shown in FIG. 4, and principles of the steps are not repeated herein.

The data processing system based on electronic payment behaviors provided in the embodiment of the present invention maps, in the user information mapping relation database storing multiple pieces of information of the user, the first user information of the users viewing specified content data collected from the acquired user log information with the second user information of the user paying for the product or service related to the specified content data collected from the acquired consumption information of the users' consumption via electronic payment, thereby acquiring the user behavior association data indicating that the first user information and the second user information belong to the same user. The solution associates Internet-surfing behavior data of users with their consumption behavior data by using the mapping relations between multiple pieces of user information corresponding to the same user as a bridge, so that a merchant or user performs targeted data mining by using the user behavior association data to acquire more valuable information.

Further, the solution of this embodiment further provides a specific instance of performing data mining through acquired user behavior association data, that is, the online consumption information, such as the in-store consumption rate, of the users is acquired based on the specified content viewed by the users when surfing the Internet and user conditions of the users using electronic payment, to facilitate subsequent data mining.

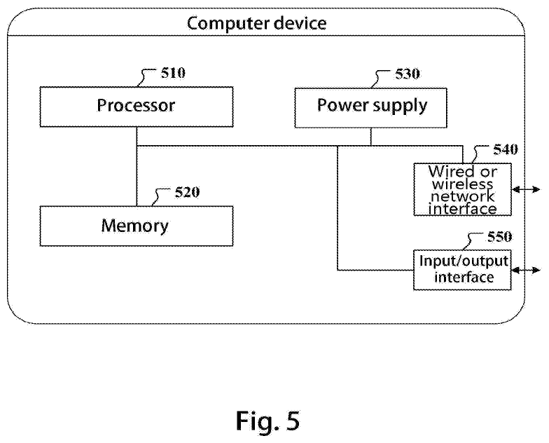

FIG. 5 is a schematic structural diagram of a computer device provided in an embodiment of the present invention. Referring to FIG. 5, the computer device may be configured to implement the data processing method based on electronic payment behaviors provided in the above embodiment.

Specifically:

The computer device may vary significantly due to different configurations or performances, and may include one or more processors (e.g., Central Processing Units (CPUs)) 510 and a memory 520. The memory 520 may be a temporary memory or a permanent memory. The memory 520 may store one or more programs, and each program may include a series of instruction operations for the computer device. Further, the processor 510 may communicate with the memory 520, and a series of instruction operations in the memory 520 are executed in the computer device. Specifically, the memory 520 further stores data of one or more operating systems, such as Windows Server™, Mac OS X™, Unix™, Linux™, and Free BSD™. The computer device may further include one or more power supplies 530, one or more wired or wireless network interfaces 540, one or more input/output interfaces 550, and the like.

Specifically, in this embodiment, the computer device includes one or more processors 510, a memory 520, and one or more programs. The one or more programs are stored in the memory 520, and are configured such that the one or more processors 510 execute instructions for executing the data processing method based on electronic payment behaviors included in the one or more programs, the method comprising: acquiring log information formed by users' Internet-surfing; acquiring consumption information generated by the users' consumption via electronic payment; collecting, from the log information, first user information of users viewing specified content data; collecting, from the consumption information, second user information of users paying for a product or service related to the specified content data; and mapping the first user information with the second user information based on a user information mapping relation database storing multiple pieces of information of the user, to acquire user behavior association data indicating that the first user information and the second user information belong to a same user.

Further, the memory 520 further includes instructions for executing the following processing: generating online consumption information of the users based on the acquired user behavior association data indicating that the first user information and the second user information belong to the same user.

Moreover, the memory 520 further includes instructions for executing the following processing: generating in-store consumption rate information of the users based on a number of first users and a number of second users corresponding to the user behavior association data.

Further, the user information includes at least one of: a Cell phone Unique Identification (CUID), a User Identification number (User ID), and a Media Access Control (MAC) address of the user.

The computer device provided in the present invention associates, by using a pre-generated user information mapping relation database, behavior information about users' viewing content data when surfing the Internet with consumption information about the users' consumption via electronic payment, thereby implementing targeted data mining, and acquiring more valuable information.

Further, the present invention further implements specific data association by using the online consumption information, e.g. the in-store consumption rate, of the user as a specific data mining object.

Finally, it should be noted that the above embodiments are merely used for describing the technical solution of the present invention, instead of limiting the present invention; although the present invention is described in detail with reference to the foregoing embodiments, persons of ordinary skill in the art should understand that they can still make modifications to the technical solutions described in the above embodiments, or make equivalent replacements on some or all of the technical features thereof; these modifications or replacements are not intended to make the essences of the corresponding technical solutions depart from the scope of the technical solutions of the embodiments of the present invention.

1. A data processing method based on electronic payment behaviors, comprising:
acquiring log information formed by users' Internet-surfing;
acquiring consumption information generated by the users' consumption via electronic payment;
collecting, from the log information, first user information of users viewing specified content data, the specified content data being data on a specified product or service;
the specified content data being data on a specified product or service;
collecting, from the consumption information, second user information of users paying for the product or service related to the specified content data; and
mapping the first user information with the second user information based on a user information mapping relation database storing multiple pieces of information of the users, to acquire user behavior association data indicating that the first user information and the second user information belong to a same user; wherein the user information comprises at least one of: a Cell phone Unique Identification (CUID), or a Media Access Control (MAC) address of the user.

2. The method according to claim 1, further comprising:
generating online consumption information of the users based on the acquired user behavior association data indicating that the first user information and the second user information belong to the same user.

3. The method according to claim 2, wherein the generating the online consumption information of the users based on the acquired user behavior association data indicating that the first user information and the second user information belong to the same user comprises:
generating in-store consumption rate information of the users based on a number of first users and a number of second users corresponding to the user behavior association data.

4. A computer device, comprising:
a processor;
a memory; and
one or more programs, stored in the memory, and configured such that the one or more
processors execute instructions for executing a data processing method based on electronic payment behaviors comprised in the one or more programs, the data processing method based on electronic payment behaviors comprising:
acquiring log information formed by users' Internet-surfing;
acquiring consumption information generated by the users' consumption via electronic payment;
collecting, from the log information, first user information of users viewing specified content data, the specified content data being data on a specified product or service;
collecting, from the consumption information, second user information of users paying for the product or service related to the specified content data; and
mapping the first user information with the second user information based on a user information mapping relation database storing multiple pieces of information of the users, to acquire user behavior association data indicating that the first user information and the second user information belong to a same user; wherein the user information comprises at least one of: a Cell phone Unique Identification (CUID), or a Media Access Control (MAC) address of the user.

5. The device according to claim 4, wherein the data processing method based on electronic payment behaviors further comprising:
generating online consumption information of the users based on the acquired user behavior association data indicating that the first user information and the second user information belong to the same user.

6. The device according to claim 5, wherein the generating the online consumption information of the users based on the acquired user behavior association data indicating that the first user information and the second user information belong to the same user comprises:
generating in-store consumption rate information of the users based on a number of first users and a number of second users corresponding to the user behavior association data.

7. A non-transitory storage medium storing one or more programs, the one or more programs when executed by an apparatus, causing the apparatus to perform a data processing method based on electronic payment behaviors, the data processing method based on electronic payment behaviors comprising:
acquiring log information formed by users' Internet-surfing;
acquiring consumption information generated by the users' consumption via electronic payment;
collecting, from the log information, first user information of users viewing specified content data, the specified content data being data on a specified product or service;
collecting, from the consumption information, second user information of users paying for the product or service related to the specified content data; and
mapping the first user information with the second user information based on a user information mapping relation database storing multiple pieces of information of the users, to acquire user behavior association data indicating that the first user information and the second user information belong to a same user; wherein the user information comprises at least one of: a Cell phone Unique Identification (CUID), or a Media Access Control (MAC) address of the user.
